(19) United States
(12) Patent Application Publication
(10) Pub. No.: US 2015/0059411 A1
(43) Pub. Date: Mar. 5, 2015

(54) METHOD OF SEPARATING A GLASS SHEET FROM A CARRIER

(71) Applicant: Corning Incorporated, Corning, NY (US)

(72) Inventors: Geunsik Lim, Corning, NY (US); Robert Stephen Wagner, Corning, NY (US); James Joseph Watkins, Corning, NY (US)

(21) Appl. No.: 14/466,460

(22) Filed: Aug. 22, 2014

Related U.S. Application Data
(60) Provisional application No. 61/871,543, filed on Aug. 29, 2013.

(51) Int. Cl. C03B 33/08; C03B 33/023

(52) U.S. Cl. CPC C03B 33/082; C03B 33/023
USPC 65/112

(57) ABSTRACT

A method of separating a thin glass substrate from a carrier plate to which edge portions of the glass substrate are bonded, including irradiating a surface of the glass substrate with a pulsed laser beam, the laser beam moving along a plurality of parallel scan paths within a raster envelope, producing relative motion between the raster envelope and the glass substrate so that the raster envelope is moved along an irradiation path on the unbonded central portion. The irradiating produces ablation of the glass substrate along the irradiation path that forms a channel having a width W₁ at the first surface greater than a width W₂ at the second surface and extending through the thickness of the glass substrate, thus separating a thin glass sheet from the glass substrate-carrier plate assembly.

### PRIORITY

This application claims the benefit of priority under 35 U.S.C. §119 of U.S. Provisional Application Ser. No. 61/871543 filed on Aug. 29, 2013, the content of which is relied upon and incorporated herein by reference in its entirety.

### BACKGROUND

1. Field

The present invention relates to a method of separating a glass substrate from a carrier plate, and more particularly to a method of removing a thin glass sheet from a carrier plate using laser ablation.

2. Technical Background

Typically, electronic devices produced using glass substrates, such as liquid crystal displays or organic light emitting displays employ glass substrates have employed glass substrates having a thickness in a range from about 0.5 to about 0.7 mm. However, recent advances in glass manufacturing have enabled the production of glass substrates having thicknesses less than about 0.3 mm, and in some cases less than 0.1 mm. The manufacture of glass substrates with such extraordinarily thin profiles may have a significant impact on device design, enabling thinner devices and, in some instances, flexible displays.

Notwithstanding the advantages to device design facilitated by very thin glass substrates, the processing of such thin substrates without damaging the substrate can be difficult. Accordingly, methods have been devised to bond the glass substrates to a carrier plate to form an assembly, processing the glass substrate, and then removing the processed glass substrate from the carrier plate. Nevertheless, removing the glass substrate from the carrier plate can still present difficulties.

### SUMMARY

In accordance with the present disclosure, methods for removing a thin glass substrate from a carrier plate without significant damage to the carrier plate are described. The methods include irradiating an unbonded portion of the glass substrate with a laser beam having a pico-second time scale pulse duration and a high repetition rate to ablate glass from the glass substrate and form a channel in the glass substrate. If the channel extends through the entire thickness of the glass substrate, and the channel is formed in a portion of the glass substrate that is not bonded to the carrier plate, at least a portion of the unbonded portion bounded by the channel can be removed from the carrier plate. The width of the channel can be selected to reduce the potential for damage to the removed portion by contacting the newly-freed portion with the portion of the glass substrate that remains bonded to the carrier plate. Because the laser parameters (e.g. pulse rate, power, pulse duration) are selected such that the carrier plate is not substantially damaged by the laser beam, the carrier plate may be re-used if desired after the unbonded portion is removed by subsequent removal of the bonded portion.

Accordingly, in one aspect a method of separating a glass sheet from a carrier plate is disclosed comprising: providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate; irradiating the first surface of the glass substrate along an irradiation path over the unbonded central portion with a pulsed laser beam, the irradiating producing an ablation of the glass substrate along the irradiation path that forms a channel extending through the thickness of the glass substrate that separates the central portion from the edge portion, the channel having a first width at the first surface greater than a second width at the second surface; removing at least a portion of the central portion of the glass substrate from the assembly to produce a glass sheet; and wherein the edge portion of the glass substrate remains bonded to the carrier plate during the removing the at least a portion of the central portion. The laser beam may be moved in a raster pattern during the irradiating, the raster pattern defining a raster envelope. A thickness of the glass substrate the may be equal to or less than 0.7 mm, equal to or less than 0.5 mm, equal to or less than 0.3 mm, equal to or less than 0.1 mm or equal to or less than 0.05 mm The second width of the channel is preferably equal to or greater than 10 μm, such as equal to or greater than 20 μm, equal to or greater than 30 μm, equal to or greater than 50 μm. The width of the channel should be sufficient to provide clearance for removal of the at least a portion of the central portion without incurring contact between the edge portion. In most cases, the second width of the channel can be equal to or less than 100 μm, for example, in a range from about 40 μm to about 80 μm.

The laser beam may have, for example, a pulse duration equal to or less than 100 picoseconds, and an intensity distribution of the laser beam perpendicular to a longitudinal axis of the laser beam is preferably Gaussian. The carrier plate is not separated by the laser beam during the irradiating.

In another aspect, a method of separating a glass sheet from a carrier plate is described comprising: providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate; irradiating the first surface of the glass substrate with a pulsed laser beam, the laser beam moving along a plurality of parallel scan paths within a raster envelope; producing relative motion between the raster envelope and the glass substrate so that the raster envelope is moved along an irradiation path on the unbonded central portion, the irradiating producing an ablation of the glass substrate along the irradiation path that forms a channel extending through the thickness of the glass substrate and separates at least a portion of the central portion from the edge portion, the channel having a width W₁ at the first surface greater than a width W₂ at the second surface; removing the at least a portion of the unbonded central portion of the glass substrate from the assembly to produce a glass sheet; and wherein the carrier plate is not separated by the laser beam during the irradiating. The plurality of scan paths are preferably parallel with the irradiation path, and the laser beam preferably forms a spot on the first surface of the glass substrate, wherein a full width half max diameter of the spot is equal to or greater than a perpendicular distance between adjacent scan paths. In accordance with the present embodiment, the edge portion of the glass substrate remains bonded to the carrier plate during the removing the at least a portion of the central portion, although the edge portion may be unbonded from the carrier plate after the at least a portion of the unbonded central portion is removed from the assembly.

In still another aspect, a method of separating a glass sheet from a carrier plate is disclosed comprising providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate; irradiating the first surface of the glass substrate with a pulsed laser beam, the laser beam moving along a plurality of parallel scan paths within a raster envelope; producing relative motion between the raster envelope and the glass substrate so that the raster envelope is moved along an irradiation path on the unbonded central portion that is parallel with the plurality of parallel scan paths, the irradiating producing an ablation of the glass substrate along the irradiation path that forms a channel having a width W₁ at the first surface greater than a width W₂ at the second surface and extending through the thickness of the glass substrate; removing the at least a portion of the unbonded central portion of the glass substrate from the assembly; and wherein the carrier plate is not separated by the laser beam during the irradiating. Preferably, the plurality of scan paths are parallel with the irradiation path, and the laser beam forms a spot on the first surface of the glass substrate wherein a full width half max diameter of the spot is equal to or greater than a perpendicular distance between adjacent scan paths. In accordance with embodiment disclosed herein, the edge portion of the glass substrate remains bonded to the carrier plate during the removing the at least a portion of the central portion.

Additional features and advantages of the embodiments disclosed herein will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are intended to provide an overview or framework for understanding the nature and character of the embodiments claimed. The accompanying drawings are included to provide a further understanding of the embodiments, and are incorporated into and constitute a part of this specification. The drawings, together with the description, serve to explain the principles and operations of the disclosed embodiments.

### BRIEF DESCRIPTION OF THE DRAWINGS

FIG. 1 is an exploded edge view of an assembly comprising a thin glass substrate at least partially bonded to a carrier plate;

FIG. 2 is a top view of the assembly of FIG. 1;

FIG. 3 is a schematic view of a separating apparatus for separating at least a portion of an unbonded portion of the glass substrate of FIGS. 1 and 2 from the carrier plate;

FIG. 4 is a schematic view of an exemplary raster patter illustrating a raster envelope that moves along and relative to an irradiation path on the glass substrate;

FIG. 5A is a cross sectional view of the glass substrate of FIGS. 1 and 2, seen without the carrier plate, and illustrating the ablation channel formed by irradiation from a pulsed laser beam;

FIG. 5B is a close-up view of the channel of FIG. 5A;

FIG. 6 is an edge view of the assembly of FIGS. 1 and 2 during removal of the at least a portion of the unbonded central portion of the glass substrate after irradiation by the laser beam.

### DETAILED DESCRIPTION

Reference will now be made in detail to the embodiment(s) of the present disclosure, examples of which are illustrated in the accompanying drawings. Whenever possible, the same reference numerals will be used throughout the drawings to refer to the same or like parts.

In conventional laser glass cutting processes the separation of glass into individual pieces relies on laser scribing and separation through crack propagation by mechanically or thermally induced stress. Nearly all current laser cutting techniques exhibit one or more shortcomings (1) they are limited in their ability to perform a free form shape cut from thin glass on a carrier plate due to a large heat-affected zone (HAZ) associated with a long (nanosecond scale) laser pulse, (2) they produce a thermal stress that often results in cracking of the surface near the laser irradiated region due to a shock wave and uncontrolled material removal, and/or (3) they can easily damage the carrier plate.

A laser cutting process based on thermal crack propagation is applicable for thin glass on a carrier plate. However, this approach can include another shortcoming. When extracting the thin glass substrate from the carrier plate, contact between the edges of the newly formed pieces can damage the thin glass in the form of chipping or micro-cracking if a sufficient gap between the adjacent edges does not exist. Such chipping or micro-cracking can decrease the edge strength of the glass and compromise the integrity of the separated substrate. Moreover, cracking in unwanted directions can occur, thereby potentially destroying the glass substrate.

While laser ablation cutting of thin glass exhibits a relatively slow processing speed due to low output power and pulse energy, it can also result in little to no crack formation near the ablation region, the ability to free-form shape the cut and controllable cutting thickness by adjusting a focal length of the laser beam, thereby avoiding damage to the underlying carrier plate surface. It is desirable that edge cracking and residual edge stress are avoided in certain glass substrates, such as glass substrates for electronic devices like flat panel displays, as damage typically originates at the edges of the glass, even when stress is applied to the center because originating flaws in the glass are more likely to occur at the edges. The high peak power of ultrafast pulsed lasers can be used to avoid these problems by employing cold ablation cutting without a measurable heat effect on the glass. Laser cutting using ultrafast pulsed lasers produces essentially no residual stress in the glass resulting in higher edge strength.

In the thermal regime, melting and ablation occur after the excited electrons redistribute energy to the glass lattice and the electrons and the lattice remain in equilibrium within the duration of the laser pulse. The time scale for the material to reach a common temperature is determined by the electron-phonon coupling constant. Heat diffusion from the electrons to the lattice (electron-phonon-relaxation-time) is a material property that has a typical value on the order of 1 to 10 picoseconds. Depending on the laser fluence, the resulting temperature of the material may exceed the melting temperature, at which time melting begins at the surface and moves inward within approximately the same timescale. At a higher fluence, e.g. energy densities around 1 J/cm² with pico- and femtosecond pulses, the boiling point of the material is exceeded and the gas phase will nucleate homogeneously in the superheated liquid. If the rate of gas bubble formation is high in comparison to the cooling rate of the liquid, material will be explosively ejected from the surface resulting in a phase explosion, i.e., ablation. With pulsed lasers having a pulse duration on the nanosecond time scale, material is removed by thermal ablation where the material is locally heated to near the boiling temperature.

However, with ultrafast pulses on the picosecond time scale, the pulse is of sufficiently short duration that very little energy from the laser beam couples into the material as heat. The short period pulse energy goes into exciting electrons, which then causes a small section of the material to ablate, and leaves behind a very limited heat-affected zone (HAZ), typically much less than a micron, i.e., low thermal penetration depth. The material disorders non-thermally before the lattice has equilibrated with the carriers for pulses of sub-picosecond duration, even below the damage threshold. The energy from the laser pulses can be deposited in a localized region through non-linear absorption such as multiple-photon processes, examples of which are multi-photon ionization and avalanche ionization that lead to the formation of a plasma, a quasi-free charge carrier in the material consisting of a mixture of electrons and ions. Therefore, material will be removed in a manner that results in extremely fine control of the location of material removal throughout the laser beam profile. Since the plasma formation rate above a threshold that depends on the material and laser parameters increases, extremely strong, optical breakdown occurs within this parameter range. A high degree of precision during machining by non-linear absorption requires that spatially localized, reproducible, small amounts of energy are introduced into the glass material. This cold ablation avoids unwanted heat transfer almost completely, thus making the ultrafast laser an extremely promising tool, especially for high-precision procedures that require machining accuracy down to a few micro- and nanometer regimes.

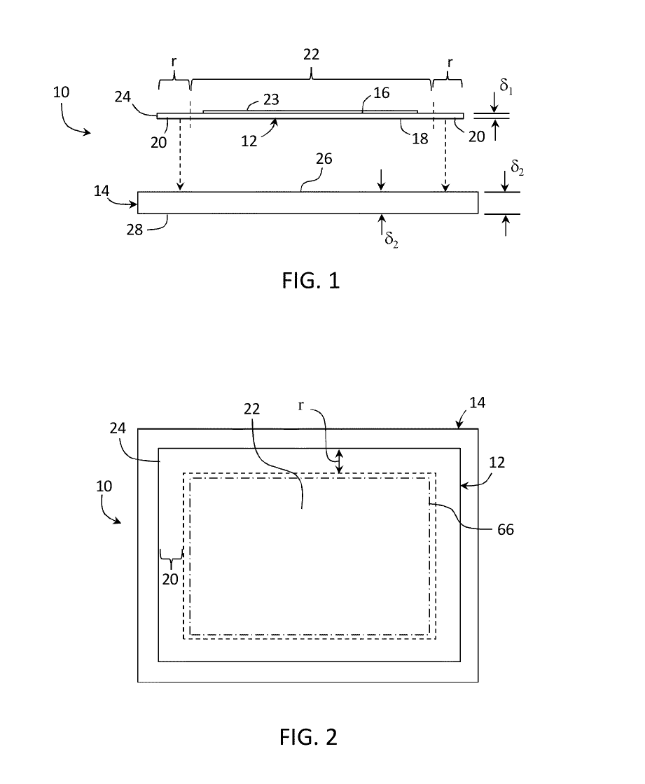

As embodied herein and depicted in the exploded cross sectional view of FIG. 1, an assembly 10 is shown comprising a glass substrate 12 positioned on a carrier plate 14. Glass substrate 12 comprises a first surface 16 and a second surface 18 generally parallel with first surface 16. Glass substrate 12 further comprises an edge portion 20 and a central portion 22. In the embodiment illustrated in FIG. 1, glass substrate 12 is rectangular in shape and comprises an edge portion 20 that forms a perimeter about central portion 22. First surface 16 and second surface 18 extend over both the edge portion 20 and the central portion 22, albeit on opposite sides of glass substrate 12. Edge portion 20 may, for example, extend inward a distance “r” in a range from about 1 mm to about 20 mm from an outer edge 24 of glass substrate 12, in a range from about 1 mm to about 10 mm or in a range from about 1 mm to 5 mm. Glass substrate 12 further comprises a thickness δ₁ extending perpendicularly between first and second surfaces 16, 18. The thickness δ₁ of glass substrate 12 maybe, for example, equal to or less than 0.7 mm, equal to or less than 0.5 mm, equal to or less than 0.3 mm, equal to or less than 0.1 mm, or equal to or less than 0.05 mm. In some embodiments, the assembly may comprise additional layers, such as a layer of silicon, a layer of indium-tin-oxide (ITO) or even one or more electronic devices such as light emitting diodes deposited on the first surface of the glass substrate, as represented by layer 23.

Still referring to FIG. 1, carrier plate 14 comprises a first surface 26 and a second surface 28 generally parallel to first surface 26. Carrier plate 14 may, for example, be formed of glass, ceramic, glass ceramic, or any other material that may form a rigid and dimensionally stable support for glass substrate 12 capable of being exposed to temperatures up to at least 700° C. without warping or undergoing significant dimensional changes. Alternatively, carrier plate 14 may be formed from the same material as glass substrate 12, or another material, wherein the glass substrate and the carrier plate have the same or similar coefficient of thermal expansion. Carrier plate 14 further comprises a thickness δ₂ extending between and perpendicular to first and second surfaces 26 and 28. The thickness of carrier plate 14 should be selected to provide suitable rigidity to the glass substrate so that subsequent processing of the glass substrate, such as the formation of the layer 23, can be done safely, without damage to the glass substrate, while the glass substrate is bonded to the carrier plate. Accordingly, the thickness of the carrier plate will be dictated by the nature of the subsequent processing and the handling of the assembly, but in example embodiments may be in a range from about 0.5 mm to 2 mm, such as, for example, between 0.7 mm and 1 mm, inclusive.

As best seen in the top view of FIG. 2, glass substrate 12 is bonded to carrier plate 14 over edge portion 20 of glass substrate 12, thus forming assembly 10. That is, second surface 18 of glass substrate 12 at edge portion 20 is bonded to first surface 26 of carrier plate 14, leaving the second surface 18 over central portion 22 unbonded to the carrier plate. For example, in the embodiment depicted in FIG. 2, glass substrate 12 is rectangular in shape, and edge portion 20 defines a generally rectangular perimeter region extending about central portion 22. Accordingly, the unbonded central portion 22 is bounded by bonded edge portion 20. The bonding may be accomplished, for example, with an organic adhesive (e.g. a polyamide) or by an inorganic material (e.g. glass frit). If re-use of the carrier plate is desired, an organic adhesive can be used to removably bond the glass substrate to the carrier plate. For example, in some embodiments the bonded portion of the substrate can be released from the carrier plate by irradiating the adhesive with a laser beam.

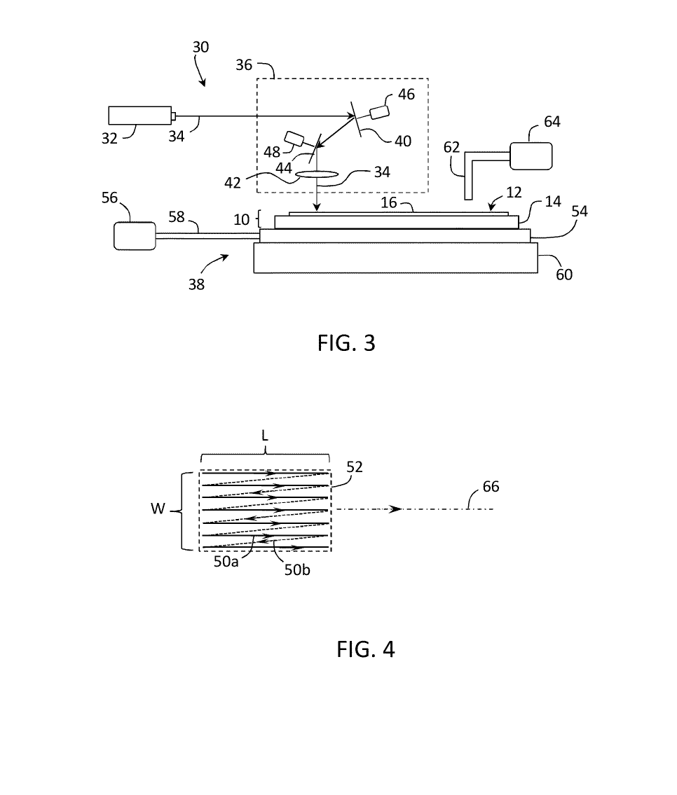

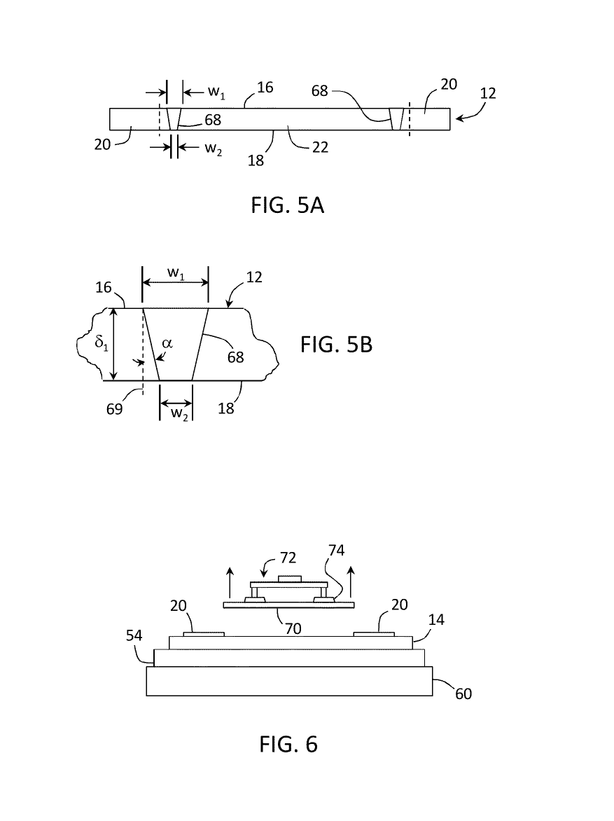

Referring now to FIG. 3, assembly 10 is shown in conjunction with a separating apparatus 30 comprising a laser beam source 32 configured to provide a pulsed laser beam 34, a laser beam steering apparatus 36 and a support device 38 for supporting assembly 10 and developing relative motion between laser beam 34 and glass substrate 12.

Laser beam source 32 is configured to provide a pulsed laser beam at a pulse repetition rate equal to or greater than 100,000 (100 k) pulses per second, equal to or greater than 200 k pulses per second or equal to or greater than 300 k pulses per second. The pulse duration may be in a range from about 10 picoseconds to about 15 picoseconds. An optical energy of the laser beam can be equal to or greater than 40 microjoules (μJ), equal to or greater than 45 μJ or equal to or greater than 50 μJ, depending on the pulse rate. The laser beam may have a Gaussian intensity distribution in a plane perpendicular to the direction of propagation of the beam. A suitable laser source may be, for example, a Super Rapid picosecond laser manufactured by Coherent®. It should be noted, however, that since the ablation described herein relies on non-linear absorption characteristics of the glass, the operating wavelength of the laser may vary according to the glass substrate composition, and may not correlate to a high degree of absorption in the glass of the glass substrate at the operating wavelength. In some embodiments, the laser wavelength can be in a range from about 355 nm to about 1064 nm, such as, for example, 532 nm. It has been shown that in some instances a shorter wavelength laser, e.g. 355 nm, can result in improved edge strength of the cut glass substrate than a longer wavelength, e.g. 1064 nm.

Laser beam steering apparatus 36 comprises a first steering mirror 40 configured to direct laser beam 34 received from laser beam source 32 to first surface 16 of glass substrate 12, and a lens 42 that can be used to focus the laser beam onto glass substrate 12. Lens 42 may be, for example, a flat field lens (e.g. F-theta lens). Alternatively, laser beam steering apparatus 36 may further comprise a second steering mirror 44, wherein first sterring mirror 40 is configured to direct laser beam 34 to second steering mirror nd second steering mirror 44 is configured to direct laser beam 34 received from first steering mirror 40 to first surface 16 of glass substrate 12. First and second steering mirrors 40 and 44 may be driven by galvanometers 46 and 48, respectively, and used separately or in conjunction with each other to produce raster scanning (“rastering”) of laser beam 34 incident on first surface 16 of glass substrate 12. Referring to FIG. 4, in raster scanning, the laser beam sweeps horizontally left-to-right along a scan path, turns off and then rapidly moves back to the left, where it turns back on and sweeps out the next scan path, displaced from the preceding scan line. Accordingly, rastering of laser beam 34 can result in a saw-tooth pattern, wherein raster scan path 50a depicts the path of the laser beam during an “on” period over which active ablation of the glass substrate occurs, and may extend for a length L, for example, between 1 mm and 10 mm. As used herein, unless otherwise indicated, the terms “on” and “off” in connection with the laser/laser beam are distinguished from the pulse intervals, and are best understood in the context of ablation, wherein “on” signifies a pulse laser beam that ablates material from the glass substrate, and “off” denotes a period wherein no ablation occurs. Laser beam steering apparatus 36 controls first and second steering mirrors 40 and 44, through their respective galvanometers, to sweep the laser beam through a plurality of adjacent, parallel scan paths 50a. On the other hand, raster scan path 50b depicts an “off” path the laser beam would illuminate if in the “on” state, wherein the beam steering device is configured to return the beam from the end position on one “on” raster scan 50a to a start position on an adjacent “on” scan path 50a. However, in some embodiments, the laser may be in an “on” state over the raster scan path 50b such that active ablation occurs over both scan paths 50a and 50b that comprise the raster pattern. As seen from FIG. 4, the plurality of scan paths 50a extend over a width W. The width W may be in a range from about 0.05 mm to about 0.2 mm, but could be larger or smaller depending on the desired width of the ablation area and hence the cut. As used hereinafter, the rectangular box represented by length L and width W will be referred to as raster envelope 52. It should be noted that other raster envelope lengths and widths may be selected as necessary to achieve the desired amount of material removal. Moreover, the preceding description of a saw-tooth shaped raster pattern should not be viewed as limiting, since other rastering patterns may be used. For example, the raster pattern could be a square-wave shape. A suitable scanning speed may be, for example, in a range from about 40 cm/second to about 80 cm/second, for example 60 cm/second.

Support device 38 is configured to support assembly 10 and to move assembly 10 in any one, two or three orthogonal directions. Support device 38 comprises a vacuum platen 54 in fluid communication with vacuum pump 56 through vacuum line 58 and may, for example, include an x-y translational stage 60. Support device 38 may be further configured to translate in a z-direction, so as to accommodate different thicknesses of the assembly 10 (e.g. various thicknesses δ₁) and facilitate focus of the laser beam on the glass substrate, for example. Separating apparatus 30 may further include a vacuum nozzle 62 in fluid communication with a second vacuum pump 64 wherein glass material ablated from glass substrate 12 by laser beam 34 is captured by the nozzle and removed from the region of glass substrate 12. Support device 38 is preferably configured to provide relative motion between raster envelope 52 and glass substrate 12 along irradiation path 66 in a range from about 5 mm/second to about 7 mm/second.

Referring to FIGS. 3 and 4, laser source 32 produces laser beam 34, which is modified by beam steering apparatus 36 to impinge on first surface 16 of glass substrate 12 along laser beam irradiation path 66. Translating assembly 10 produces relative motion between assembly 10 and laser beam 34 such that raster envelope 52 is moved along irradiation path 66. As raster envelope 52 is moved along irradiation path 66, material is ablated from glass substrate 12, producing channel 68 in the glass substrate, as shown in FIGS. 5A and 5B.

FIGS. 5A and 5B depict a cross sectional side view of glass substrate 12 after irradiation by laser beam 34, wherein the irradiation of glass substrate 12 by laser beam 34 produces through ablation channel 68 that extends through thickness 81 of glass substrate 12. Thickness δ₁ may be, for example, equal to or less than 0.5 mm, equal to or less than 0.3 mm, equal to or less than 0.1 mm, or equal to or less than 0.05 mm. Glass substrate 12 is shown separately so as not to obscure features of the figure. It should be readily apparent from FIGS. 5A and 5B that a first width W₁ of channel 68 at first surface 16 of glass substrate 12 is greater than second width W₂ at second surface 18. Accordingly the walls of channel 68 are positioned at an angle α relative to a normal 69 to the surfaces of glass substrate 12. This can be seen more clearly from FIG. 5B showing a close-up view of channel 68. Angle α may be, for example, in a range from about 10 degrees to about 14 degrees. Preferably, W₂ is between 8 μm and 12 μm. Knowing the desired W₂ that will be effective to reduce the potential for contact between the newly-formed ablated edges, W₁ may then be easily calculated. For example, selecting a value for W₂ of 10 μm, wherein a nominal value for angle α relative to surface normal 69 (normal to first surface 16) is 12 degrees, the resultant width W₁=2*δ₁ Tan(α)+W₂=52.5 μm. The overall width of channel 68 (i.e. widths W₁ and W₂) can be varied, for example, by selecting an appropriate raster envelope width W and/or by varying the spot size of laser beam 34 on glass substrate 12.

Preferably, a spot size of the laser beam, defined herein as the full width half max (FWHM) diameter of the spot on glass substrate 12 irradiated by laser beam 34, should be smaller than the width of channel 68, but larger than the distance between adjacent parallel scans 50a of the laser beam within the raster envelope while the laser is in an “on” state so that successive passes of the irradiating laser spot overlap.

Referring now to FIGS. 2 and 3, glass substrate 12 is bonded to carrier plate 14 only along the edge portions 20 of the glass substrate, leaving the central portion 22 not bonded to carrier plate 14. Vacuum pump 56 is used to draw a vacuum within vacuum platen 54 which couples assembly 10 to the vacuum platen. First steering mirror 40, and, if present, second steering mirror 44, can be used to steer laser beam 34 over first surface 16 of glass substrate 12 in a predetermined raster pattern (e.g. raster paths 50a and 50b) that forms a raster envelope 52. Laser beam irradiation path 66 is preferably inward of the bonded edge portion 20, relative to edge 24, and sufficiently inward of bonded edge portion 20 that channel 68 is entirely within the unbonded portion of glass substrate 12. Stage 60 can be used to produce relative motion between the raster envelope 52 of laser beam 34 and glass substrate 12 such that raster envelope 52 traverses beam irradiation path 66. As laser beam 34 impinges on and irradiates first surface 16 along laser beam irradiation path 66, the short-duration pulses ablate the glass substrate along laser beam irradiation path 66, creating channel 68, wherein a first width W₁ of channel 68 at first surface 16 is greater than a second width W₂ of channel 68 at second surface 18. Channel 68 may be, for example, a closed channel insofar as laser beam irradiation path 66 is a closed path, where a beginning point of the path intersects with an end point for the path. Accordingly, channel 68 can be a closed channel that completely separates at least a portion 70 of central portion 22 from edge portion 20. Once channel 68 has been formed, that portion 70 of central portion 22 that has been separated from edge portion 20 may be removed by lifting the separated portion from the assembly. Separated portion 70 may be lifted by lifting apparatus 72 comprising one or more suction devices 74 (e.g. suction cups) that engage with and hold separated portion 70. The angled walls of channel 68 reduce the risk of contact between the separated portion 70 and the remaining portion of glass substrate 12 still affixed to carrier plate 14 during the removal process.

It should be apparent from the preceding description that although presented in the context of a rectangular irradiation path, the irradiation path could be other shapes, such as circular, oval, elliptical or even free-form.

It will be apparent to those skilled in the art that various modifications and variations can be made to embodiments disclosed herein without departing from the spirit and scope of the disclosed embodiments. Thus, it is intended that the present disclosure cover the modifications and variations of these embodiments provided they come within the scope of the appended claims and their equivalents.

What is claimed is:

1. A method of separating a glass sheet from a carrier plate comprising:
providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate;
irradiating the first surface of the glass substrate along an irradiation path over the unbonded central portion with a pulsed laser beam, the irradiating producing an ablation of the glass substrate along the irradiation path that forms a channel extending through the thickness of the glass substrate that separates the central portion from the edge portion, the channel having a first width at the first surface greater than a second width at the second surface;
removing at least a portion of the central portion of the glass substrate from the assembly to produce a glass sheet; and
wherein the edge portion of the glass substrate remains bonded to the carrier plate during the removing the at least a portion of the central portion.

2. The method according to claim 1, wherein the laser beam is moved in a raster pattern during the irradiating.

3. The method according to claim 1, wherein the thickness of the glass substrate is equal to or less than 100 μm.

4. The method according to claim 1, wherein a pulse duration of the pulsed laser beam is equal to or less than 100 picoseconds.

5. The method according to claim 1, wherein the carrier plate is not separated by the laser beam during the irradiating.

6. The method according to claim 1, wherein an intensity profile of the laser beam perpendicular to a longitudinal axis of the laser beam is Gaussian.

7. The method according to claim 1, wherein the second width of the channel is equal to or greater than 10 μm.

8. A method of separating a glass sheet from a carrier plate comprising:
providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate;
irradiating the first surface of the glass substrate with a pulsed laser beam, the laser beam moving along a plurality of parallel scan paths within a raster envelope;
producing relative motion between the raster envelope and the glass substrate so that the raster envelope is moved along an irradiation path on the unbonded central portion, the irradiating producing an ablation of the glass substrate along the irradiation path that forms a channel extending through the thickness of the glass substrate and separates at least a portion of the central portion from the edge portion, the channel having a width W₁ at the first surface greater than a width W₂ at the second surface;
removing the at least a portion of the unbonded central portion of the glass substrate from the assembly to produce a separated glass sheet; and
wherein the carrier plate is not separated by the laser beam during the irradiating.

9. The method according to claim 8, wherein the plurality of scan paths are parallel with the irradiation path.

10. The method according to claim 8, wherein the laser beam forms a spot on the first surface of the glass substrate, and a full width half max diameter of the spot is equal to or greater than a perpendicular distance between adjacent scan paths.

11. The method according to claim 8, wherein W₂ is equal to or greater than 10 μm.

12. The method according to claim 8, wherein the edge portion of the glass substrate remains bonded to the carrier plate during the removing the at least a portion of the central portion.

13. A method of separating a glass sheet from a carrier plate comprising:
providing an assembly comprising a glass substrate and a carrier plate, the glass substrate having a first surface, a second surface and a thickness therebetween, the glass substrate further comprising an edge portion and a central portion, the second surface of the glass substrate at the edge portion being bonded to the carrier plate and wherein the second surface of the glass substrate at the central portion is not bonded to the carrier plate;
irradiating the first surface of the glass substrate with a pulsed laser beam, the laser beam moving along a plurality of parallel scan paths within a raster envelope;
producing relative motion between the raster envelope and the glass substrate so that the raster envelope is moved along an irradiation path on the unbonded central portion that is parallel with the plurality of parallel scan paths, the irradiating producing an ablation of the glass substrate along the irradiation path that forms a channel having a width W₁ at the first surface greater than a width W₂ at the second surface and extending through the thickness of the glass substrate;
removing the at least a portion of the unbonded central portion of the glass substrate from the assembly; and
wherein the carrier plate is not separated by the laser beam during the irradiating.

14. The method according to claim 13, wherein the plurality of scan paths are parallel with the irradiation path.

15. The method according to claim 13, wherein the laser beam forms a spot on the first surface of the glass substrate, and a full width half max diameter of the spot is equal to or greater than a perpendicular distance between adjacent scan paths.

16. The method according to claim 13, wherein the edge portion of the glass substrate remains bonded to the carrier plate during the removing the at least a portion of the central portion.
